(19) United States
(12) Patent Application Publication
(10) Pub. No.: US 2026/0118114 A1
(43) Pub. Date: Apr. 30, 2026

(54) Light Emitting Targeting System for Pipes and Conduits

(71) Applicant: Cody Titus, Prineville, OR (US)

(72) Inventor: Cody Titus, Prineville, OR (US)

(21) Appl. No.: 19/004,122

(22) Filed: Dec. 27, 2024

Related U.S. Application Data
(60) Provisional application No. 63/615,053, filed on Dec. 27, 2023.

(51) Int. Cl. G01B 11/27; F16L 1/10

(52) U.S. Cl. CPC G01B 11/27; F16L 1/10

(57) ABSTRACT

A light emitting targeting device is provided having a body which may be coupled to the distal end of a pipe. A light beam emitted from the body, while coupled to the pipe, is projected in line with the center axis of the pipe. Contact of the light beam with a surface adjacent the distal end of the pipe provides a target for the formation of a hole through the surface for an extension of the pipe therethrough.

This application claims priority to U.S. Provisional Patent Application Ser. No. 63/615,053 filed on Dec. 27, 2023.

### FIELD OF THE INVENTION

The disclosed device relates to the positioning of pipes and conduits and the likes within structures. More particularly, it relates to a light emitting or laser-enabled device configured for determining a route for pipes and conduits through walls and impediments during the positioning of such pipes and conduits within a building.

### BACKGROUND OF THE INVENTION

Pipes and conduits have become an intricate component of modern buildings. Where water or fluid is supplied to various areas of a building, pipes must be routed from the supply of the fluid to various destinations. Where conduits are employed to surround and communicate wiring they must follow paths from their origin to the various destinations for such in a building. In the physical routing of such pipe and conduit, some may be simply routed through empty spaces in basements and overhead building areas. However, as is the case with the majority of building structures, the pipes or conduits must be routed through walls and floors. Such a routing, conventionally, requires the formation of openings or passages through walls or floors which are slightly larger than the circumference of the pipe or conduit to allow passage therethrough.

The forgoing examples of the routing of pipe and conduit and limitations related therewith are intended to be illustrative and not exclusive, and they do not imply any limitations on the disclosed laser targeting device described and claimed herein. Various additional limitations of the related art will become apparent to those skilled in the art upon reading and understanding the specification below and the accompanying drawings.

In this respect, before explaining at least one embodiment of the laser targeting device for the marking of walls and floors for conduit passages herein in detail, it is to be understood that the laser hole targeting invention is not limited in its application to the details of construction and to the arrangement of the components set forth in the following description or illustrated in the drawings nor the steps outlined in the specification.

Also, it is to be understood that the phraseology and terminology employed herein are for the purpose of description and should not be regarded as limiting in any manner. As such, those skilled in the art will appreciate that the conception upon which this disclosure is based may readily be utilized as a basis for designing other methods and systems for carrying out the several purposes of the laser targeting device disclosed herein. It is important, therefore, that the claims be regarded as including such equivalent construction insofar as they do not depart from the spirit and scope of the present invention.

### SUMMARY OF THE INVENTION

The light emitting targeting system herein described and disclosed provides an easily employed tool for the marking of walls or floors or other surfaces of a building with an illuminated target position for the locating of a hole therein. In the light emitting targeting device herein, the target position provided by the projection and illumination of a target spot on the wall or floor or ceiling or other surface adjacent the operatively engaged body of the device, will preferably be aligned with the center axis of the pipe or conduit onto which the body of the device herein is operatively engaged.

In the system herein a body of the device is configured on one side with an engaging connector which will removably couple the body of the device to the distal end of a pipe or conduit. By coupled or coupling herein is meant, that the body of the device engages with either the interior of the sidewall forming the pipe or conduit or the exterior thereof, or both, such that the coupling centrally positions a light emitter centrally located upon the body of the device such that beam of light emitted therefrom is aligned with the center axis of the pipe or conduit to which the body is removably coupled.

In one mode of the device herein, the coupler or connection is provided by a plurality of engagement points which operatively engage with the sidewall of the distal end of an installed pipe or conduit. The couplers or engagement points are formed by a plurality of annular recesses formed adjacent to annular shoulders or walls surrounding them. Each of these annular recesses is concentrically positioned around each other annular recess and shoulder from largest to smallest.

The removable coupling of the body of the device is accomplished by sliding a recess area adjacent a circular shoulder of the body of the device over the distal end of an installed pipe or conduit. In some operations of the device, the coupling will occur with the exterior circumference of a shoulder forming a sliding contact against the interior surface of the wall surrounding an axial passage of a pipe or conduit. In other connections of the device, the interior surface shoulder will form a frictional engagement with the exterior surface of the pipe or conduit. In some couplings, both the interior and exterior surfaces of the wall forming the pipe or conduit may be frictionally engaged by concentric shoulder surfaces.

The shoulders of the body may be formed of flexible material. In this coupling the user employs the recess having a circumference thereof which will allow the circular wall surrounding it slide upon the interior or the exterior of the sidewall forming the pipe or conduit to which it is engaging. The annular recesses defining surrounding circular shoulders or walls may be formed into a first end of the body or may be provided by a series of concentric shoulders formed at the first end of the body where each successive shoulder from the first end of the body toward the second end thereof is larger. Alternatively, the concentric shoulders surrounded by recesses may all be positioned within an exterior sidewall of the body of the device although forming projecting successively larger shoulders and recesses makes it easier to couple the body of the device to the open end of a pipe or conduit since the user may view the coupling more easily.

A central recess is formed in the body of the device herein which is centered within all of the other surrounding recesses and shoulders forming the engaging connector of the body of the device to a pipe. A light emitter is positioned within this central recess whereby light emitted from the endwall of the body of the device will be axially aligned with the center axis of the device and the installed pipe or conduit onto which the body of the device is engaged. By light emitter herein is meant any light emitter which will emit a highly focused beam of light therefrom, such as a laser or light emitting diode or light emitter with lenses which form a highly focused light beam.

The light emitter has an onboard electric power supply, such as a battery and has an activation switch which will communicate power from the power supply to the light emitter once the switch is positioned to close the connection thereto. This switch may be any switch that will provide this function, such as a twisting on/off switch or, in some cases, a mercury switch or sensing electronic switch which will actuate when sensing darkness which will occur when the body of the device is operatively engaged to the distal end of an installed pipe or conduit.

### OBJECTS OF THE INVENTION

An object of this invention is the provision of a light beam emitting targeting component which when coupled with an open end of a pipe or conduit, will provide an illuminated target area on a wall or floor or other building surface useable for the formation of a hole therein sized for passage of a conduit or pipe therethrough.

It is another object of this invention to provide such a light emitting targeting component which is configured with an engaging coupling on a first end of a body thereof which is adapted for easy engagement and disengagement with the open distal end of a plurality of pipe or conduit of differing sizes.

It is a further object of this invention to provide such a light emitting targeting component which once engaged into a distal end of an installed pipe or finally positioned conduit, will project a light beam from an emitter to illuminate a target area on an adjacent wall or floor or other surface where the projected beam on contact with the surface is axially aligned with the center axis of the pipe or conduit into which the light emitting component is engaged.

These, together with other objects and advantages of the disclosed light emitting device herein which will become subsequently apparent to those skilled in the art, reside in the details of the device construction and method herein as more fully hereinafter described and claimed, reference being had to the accompanying drawings forming a part thereof, wherein like numerals refer to like parts throughout.

With respect to the above description then, it is to be realized that the dimensional relationships for the components of the light emitting targeting invention may also include variations in size, materials, shape, form, function and manner of operation, manner of formation, assembly and use, which are deemed readily apparent and obvious to one skilled in the art subsequent to their review of this specification. Therefore, the foregoing summary and following description are considered as illustrative only of the principles of the invention to provide pipe or conduit coupled device which when so engaged will illuminate a targeted spot on a surface which is axially aligned with the pipe or conduit into which it is engaged.

Additionally, since numerous modifications and changes will readily occur to those skilled in the art subsequent to their review of this disclosure, it is not desired to limit the invention to the exact construction and operation and steps of formation and employment of the light emitting device shown and described. Accordingly, all suitable modifications and equivalent components and configurations which may be resorted to, are considered to fall within the scope of the invention.

### BRIEF DESCRIPTION OF THE DRAWINGS

The accompanying drawings, which are incorporated herein and form a part of the specification, illustrate some but not the only or exclusive examples of embodiments of the light emitting targeting device herein. It is intended that the embodiments and figures disclosed herein are to be considered illustrative of preferred modes of the device and the system rather than limiting.

FIG. 1 depicts a perspective rear view of the body of one mode of the light emitting device herein showing a plurality of concentric recesses surrounding circular shoulders and an axial center of the device where each recess and the adjacent shoulder or shoulders is sized to engage over one or two sides of a wall of a pipe or conduit of a differing sizes.

FIG. 2 depicts another mode of a body of the light emitting device herein also having a plurality of concentric recesses surrounding sides of annular shoulders where the recesses and adjacent shoulders are configured to engage with one or both sides of a wall forming a pipe or conduit wall of differing size.

FIG. 3 depicts the device of FIG. 1-2 or 5 herein having the body thereof removably engaged by a coupling connector with a distal end of a pipe or conduit and illuminating a target spot on a wall surface where the target spot is axially aligned with the center axis of the pipe or conduit onto which it is engaged.

FIG. 4 depicts the device as in FIG. 3, from an opposite view showing the body of the device herein coupled with the annular wall forming a pipe or conduit and showing the light beam emitted from an onboard light emitter which is axially aligned with the pipe or conduit.

FIG. 5 shows the light emitting device herein for targeting emitted light for openings to be formed in walls or floor surface where the body employs a plurality of differing sized circular concentric shoulders or walls adjacent where the exterior of each shoulder is adapted to engage the interior of the wall surface of a pipe or conduit.

FIG. 6 depicts the device in a similar fashion to that of FIG. 5 and shows gaps formed in the shoulders which may allow an initial flex for an easier insertion onto the open end of a pipe or conduit.

### DETAILED DESCRIPTION OF THE INVENTION

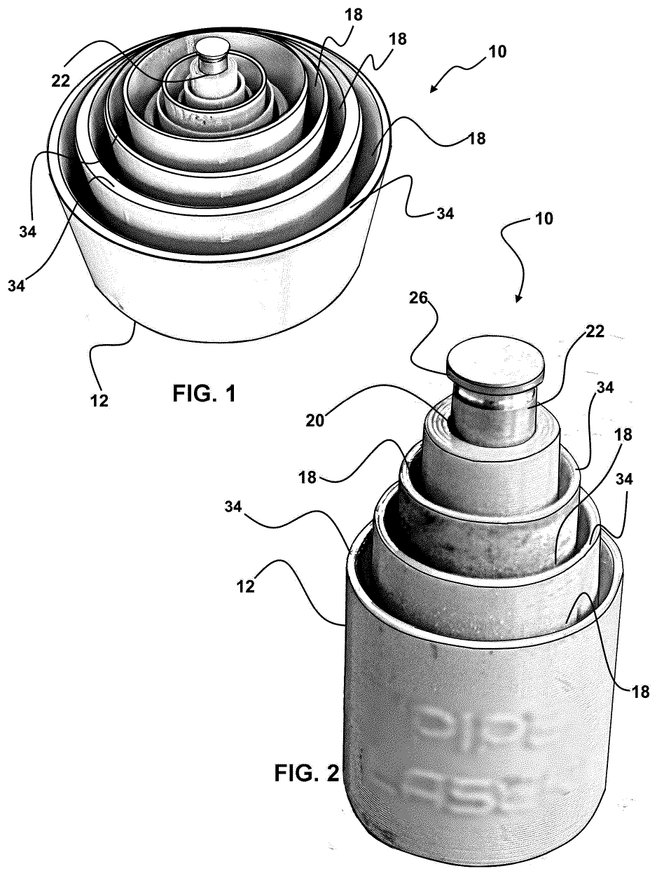

Referring now to the drawings in FIGS. 1-6, wherein similar parts of the light emitting targeting device for hole positioning are identified by like reference numerals:

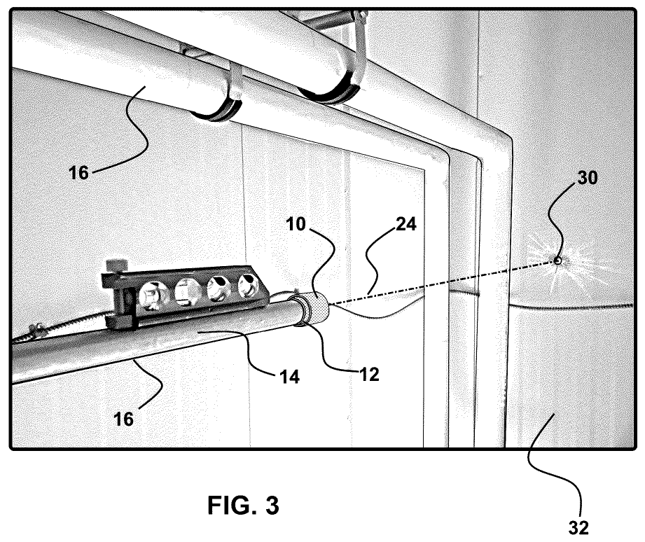

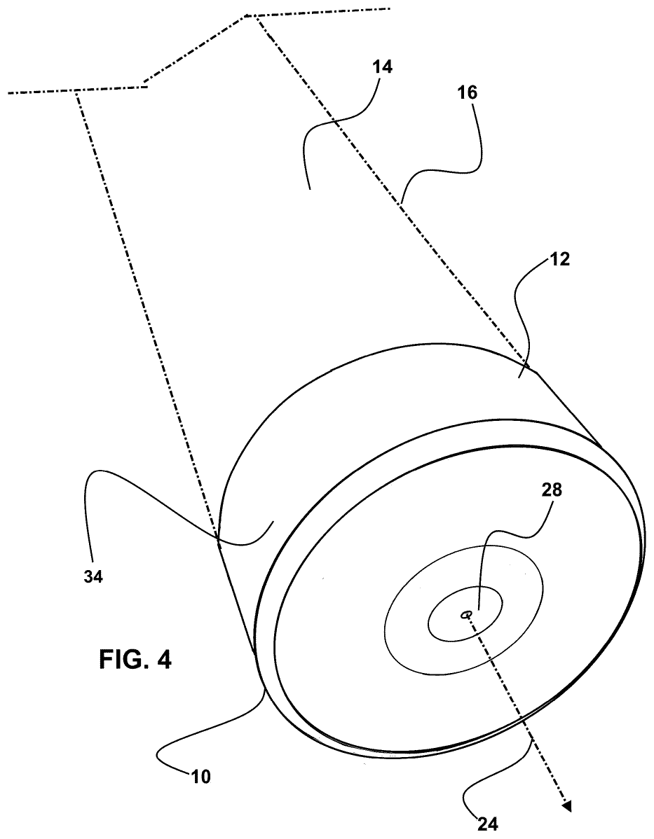

As noted, FIGS. 1 and 2 depict perspective rear views of the device 10 herein of a mode of the device 10 showing differing configurations of recesses 18 surrounding annular walls or shoulders 34 positioned adjacent the recesses 18. In FIGS. 1-3, the recesses 18 in between shoulders allow the body 12 to be coupled to a pipe or conduit, as in FIGS. 3 and 4, by sliding the appropriate sized recess 18 surrounding the shoulder 34 having an exterior circumference sized to form a sliding engagement with the interior surface of a pipe or conduit as in FIG. 3. Alternatively, the body 10 may be engaged around the exterior surface of a pipe 16 by sliding a sidewall 34 having an interior circumference which is equal to or slightly smaller than the exterior surface of the pipe or conduit 16.

The body 12 may be formed with at least one shoulder 34 sized with an exterior surface for sliding against the interior of a sidewall 14 forming a pipe or conduit 16 or around the exterior surface of the sidewall 14 forming the pipe or conduit 16. Preferably, as shown in the modes herein of the device 10, a plurality of shoulders 34 is provided to allow coupling to a plurality of pipes or conduits 16 having different diameters with differing sized interior sidewall circumferences and different sized exterior sidewall circumferences.

As shown in FIGS. 1 and 2, a body 12 of the device 10 may be configured with a plurality of engagement or coupling points which will operatively engage with the sidewall 14 (FIG. 3 or 5-6) forming a pipe or conduit 16 (FIG. 3 or 5-6) which is installed in a desired routing in a building.

The coupling of the body 12 of the device 10 with a sidewall 14 of a pipe (FIG. 4), shown in FIGS. 1 and 2, includes an engaging coupling to the distal end of a pipe or conduit 16. As shown in FIGS. 1 and 2, the engaging connection is formed by a plurality of recesses 18 surrounding a shoulder 34 each of which is concentric to the others. The body 12 may be coupled to the distal end of the pipe 16 by a sliding engagement of the exterior surface of a shoulder 34 sized to slide into the open end of the pipe 16 and against the interior of the sidewall 14.

Alternatively, the body 12 may be coupled to the distal end of a pipe or conduit 16 by sliding an interior surface of a shoulder 34 where the interior circumferential surface of the chosen sidewall 34 is substantially equal to or just slightly larger than the exterior circumference of the pipe or conduit 16. In either coupling of the body 12 to the sidewall 14 of the pipe or conduit 16, the emitted beam 24 will be automatically substantially aligned with the center axis of the pipe or conduit 16.

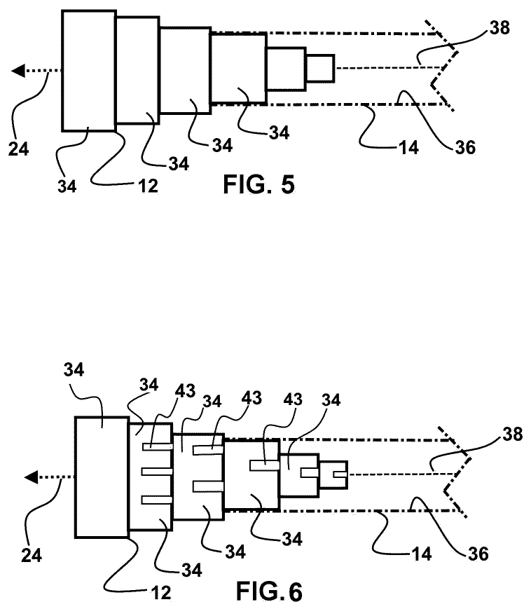

A central recess 20 cavity which is centered within all of the surrounding recesses 18 and circular shoulders 34 is configured to operatively hold a light emitter 22 therein. By light emitter 22 herein is meant any light emitting component which projects a highly focused narrow light beam 24 (FIG. 3). Such a light emitter 22 may be a laser or light emitting diode or a similar light emitter 22 where the narrow focused light beam 24 emitted is substantially axially aligned with the center axis 38 (FIG. 5) of the pipe or conduit 16 onto which the body 12 of the device 10 is engaged.

The light emitter 22, engaged within the central recess 20 of the body 12 of the device 10, has an onboard power supply, such as a battery or slow discharge capacitor or the like. A switch 26, such as a twist knob, mercury switch, accelerometer, or other switch is provided to operatively connect the battery to the light emitter 22 to energize it to produce the highly focused light beam 24.

As shown in FIGS. 3 and 4, the device 10 of FIGS. 1 and 2 or 5 and 6, once activated by the switch 26, will emit a light beam 24 from the centrally positioned light emitter 28. This light beam 24, as noted, is highly focused, such as a laser light beam and will illuminate a target spot 30 upon an adjacent surface 32.

With the body 12 of the device 10 operatively coupled to the distal end of an existing pipe or conduit 16, the light beam 24 will be aligned with the center axis 38 of the pipe or conduit 16. The target spot 30 upon a surface will, thus, be substantially aligned with the center axis 38 of the pipe or conduit 16. The target spot 30 may be marked with a marker, such as a pencil or pen or the like and thereafter a hole formed at the target spot 30. The hole, through the surface 32 formed at the target spot 30, will thus be aligned with the existing pipe or conduit 16 and allow for another section of pipe or conduit to be engaged through the hole and thereafter, to be easily engaged to the existing pipe or conduit 16.

As shown in FIG. 5, the light emitting device 10 herein may have a coupling connection to the distal end of a pipe or conduit 16 may be formed by any one of series of concentric annular shoulders 34. As shown, each consecutive annular shoulder 34 is sized slightly smaller than an adjacent larger shoulder 34. This allows the body 12 of the device 10 to engage one shoulder 34 which is sized to engage the interior surface 36 of the sidewall 14 of the pipe or conduit 16. The light beam 24 emitted from the light emitter 22 will be aligned with the center axis 38 of the pipe or conduit 16 onto which the body 12 is engaged in the same fashion as the device 10 of FIGS. 1-2.

FIG. 6 depicts the device in a similar fashion to that of FIG. 5 and shows gaps 43 formed in the shoulders 34 which may allow for an easier insertion onto the axial passage at the open end of a pipe 16 or conduit.

In a method of employment of the device 10 herein, in a first step, the body 12, having the light emitter actuated to emit a light beam 24, is placed in a coupled engagement with a distal end of a pipe 16, such as in FIGS. 5 and 6. In a next step, the position of contact of the light beam 24 with a surface 32 is determined. In a next step, an opening is formed at the position of contact of the light beam 24 with the surface 32 for positioning of an extension of the pipe therethrough.

As noted above, while the present light emitting hole position targeting invention has been described herein with reference to particular embodiments thereof and steps in the method of employment of the modes thereof, a latitude of modifications, various changes and substitutions are intended in the foregoing disclosures, it will be appreciated that in some instance some features or steps in configuration light emitting targeting invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A light emitting targeting device comprising:
a body, said body extending between a first end and a second end;
said body having a central recess running along a central axis of said body;
a light emitter positioned within said central recess, said light emitter for emitting a focused beam of light therefrom;
said body configured at said first end for a coupled engagement to a distal end of a pipe; and
said focused beam of light being aligned with said central axis with said body in said coupled engagement, whereby said focused beam of light forms a target for the positioning of an opening through a surface upon contact with said surface.

2. The light emitting targeting device of claim 1 additionally comprising:
at least one annular shoulder positioned at said first end of said body; and
said annular shoulder having an exterior surface sized for forming said coupled engagement with said distal end of said pipe.

3. The light emitting targeting device of claim 2 additionally comprising:
said annular shoulder having an exterior circumferential surface sized for a frictional engagement with an interior circumferential surface of a wall forming said pipe.

4. The light emitting targeting device of claim 2 additionally comprising:
said annular shoulder having an annular recess therein defining an interior circumferential surface of said annular shoulder; and
said interior circumferential surface of said annular shoulder for forming a frictional engagement with an exterior circumferential surface of a wall forming said pipe.

5. The light emitting targeting device of claim 2 additionally comprising:
a plurality of annular shoulders positioned at said first end of said body; and
each of said annular shoulders of said plurality thereof having a respective said exterior surface sized for forming said coupled engagement with a different sized distal end.

6. The light emitting targeting device of claim 4 additionally comprising:
a plurality of said annular shoulders positioned at said first end of said body
each said annular shoulder having an annular recess adjacent thereto defining an interior circumferential surface of said respective annular shoulder; and
each respective said interior circumferential surface of each said annular shoulder for forming a frictional engagement with a different sized said exterior circumferential surface of a wall forming said pipe.

7. The light emitting targeting device of claim 2 additionally comprising:
gaps formed in said annular shoulder.

8. A method of use of the device of claim 1 comprising the steps of:
positioning said first end of said body to said coupled engagement with said distal end of said pipe;
determining a position of contact of said focused light beam with a surface adjacent said body; and
forming an opening in said surface for positioning of an extension of said pipe therethrough.
